(19) United States
(12) Patent Application Publication
(10) Pub. No.: US 2010/0272383 A1
(43) Pub. Date: Oct. 28, 2010

(54) SPLIT LOCKING SLEEVE

(75) Inventor: Randy Mock, Beaverton, OR (US)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: EDT CORP., Vancouver, WA (US)

(21) Appl. No.: 12/565,603

(22) Filed: Sep. 23, 2009

Related U.S. Application Data
(60) Provisional application No. 61/173,408, filed on Apr. 28, 2009.

(51) Int. Cl. F16C 43/04; F16D 1/08

(52) U.S. Cl. 384/585; 403/344

(57) ABSTRACT

The present disclosure provides a split locking sleeve for use with a shaft receivable within a portion of a bearing assembly. The split locking sleeve includes a sleeve portion having a first inner bore diameter sized and configured to receive a shaft therein. A collar portion is integrally formed with the sleeve portion, and the collar portion includes a second inner bore diameter that is smaller than the first inner bore diameter. The split locking sleeve further includes an attachment assembly comprising at least one axial slot extending along the collar portion to define first and second collar portions and at least one fastener receivable within the collar portion and configured to draw the first and second collar portions together.

### CROSS-REFERENCE TO RELATED APPLICATION

This application claims the benefit of U.S. Provisional Application No. 61/173,408, filed Apr. 28, 2009, the disclosure of which is hereby expressly incorporated by reference.

### BACKGROUND

A bearing is a device configured to allow constrained relative motion between two or more parts, typically rotary or linear movement. Rotary plane bearings are one of the simplest types of bearing and are widely used in various applications. Rotary plane bearings have no “rolling” components and typically include a shaft rotatably received within a hole. The hole may be defined within a structural component, such as a portion of a machine, or may be defined inside a bearing insert. The bearing insert may be a spherical component suitable to carry radial loads and handle moderate misalignments.

Plane bearings may be lubricated to reduce the friction between the journal (the end of the shaft inside the bearing) and the bearing insert wall, thereby allowing the shaft to rotate efficiently against the non-moving bearing surface. However, in many applications it is desirable to place a sleeve over the end of the shaft to act as a journal inside the bearing insert. The sleeve protects the shaft surface from abrasion and the normal wear caused by plane bearings. Moreover, a sleeve may be used to “replace” the damaged end of a shaft and prolong the life of a bearing. However, to effectively act as a journal inside the bearing insert, it is often desired to secure the sleeve in its position on the shaft.

In some applications, a sleeve having an integrated locking collar is employed to both protect the shaft and secure the sleeve in place. Such “locking sleeves” typically include a sleeve portion and a collar portion, wherein setscrews are threaded into the collar portion to engage the shaft at different radial positions on the shaft. However, in operating environments that include frequent temperature cycling or that impose large amounts of lateral movement on the shaft, the setscrews often vibrate loose, thereby resulting in damage to the shaft.

A separate “split” locking collar having at least twice the lateral holding power of the above-described locking sleeve may be employed to withstand such extreme environmental conditions. The split locking collar is used when the shaft is received within the bearing insert without the use of a sleeve. Typical split locking collars include an axial slot and a fastener that extends across the axial slot to draw portions of the collar together and clamp onto the shaft. The split locking collar can withstand high thrust loads and maintains its clamping force on the shaft during temperature variations. However, as noted above, the split locking collar is used only when the shaft is directly received within the bearing insert, thereby exposing the shaft to increased wear and tear and decreasing the life of the bearing.

Based on the foregoing, there is a desire to have a split locking collar or similar device integrally formed with a sleeve. However, simply forming an integrated sleeve and split locking collar assembly results in an integrated design that fails mechanically in many aspects. Specifically, such an integrated design creates areas of high stress and strain at the intersection of the collar and sleeve as well as at the inner end of the axial slot. As such, when the collar portion is clamped down onto the shaft to secure the sleeve in its position, the split locking sleeve often crinkles, cracks, or otherwise deforms in the areas of concentrated stress and strain. Moreover, with the sleeve portion integrally formed with the collar portion, the sleeve portion interferes and prevents the collar portion from effectively clamping onto the shaft.

Thus, there is a need for an improved integrated sleeve and collar design that integrates the high lateral holding power of the split locking collar and the reduced frictional benefits of the sleeve.

### SUMMARY

The present disclosure provides a split locking sleeve for use with a shaft receivable within a portion of a bearing assembly. The split locking sleeve includes a sleeve portion having a first inner bore diameter sized and configured to receive a shaft therein. A collar portion is integrally formed with the sleeve portion, and the collar portion includes a second inner bore diameter that is smaller than the first inner bore diameter. The split locking sleeve further includes an attachment assembly comprising at least one axial slot extending along the collar portion to define first and second collar portions and at least one fastener receivable within the collar portion and configured to draw the first and second collar portions together.

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

### DESCRIPTION OF THE DRAWINGS

The foregoing aspects and many of the attendant advantages of the present disclosure will become more readily appreciated by reference to the following detailed description, when taken in conjunction with the accompanying drawings, wherein:

FIG. 1 is an environmental view of a split locking sleeve constructed in accordance with one embodiment of the present disclosure, wherein the split locking sleeve is shown inserted into a bearing assembly having a bearing and a bearing housing;

FIG. 2 is an axial isometric exploded view of the embodiment illustrated in FIG. 1, showing the split locking sleeve and the bearing exploded from the bearing housing;

FIG. 3 is an isometric view of the split locking sleeve of FIG. 1; and

FIG. 4 is a cross sectional view of the split locking sleeve of FIG. 3 taken substantially along line 4-4.

### DETAILED DESCRIPTION

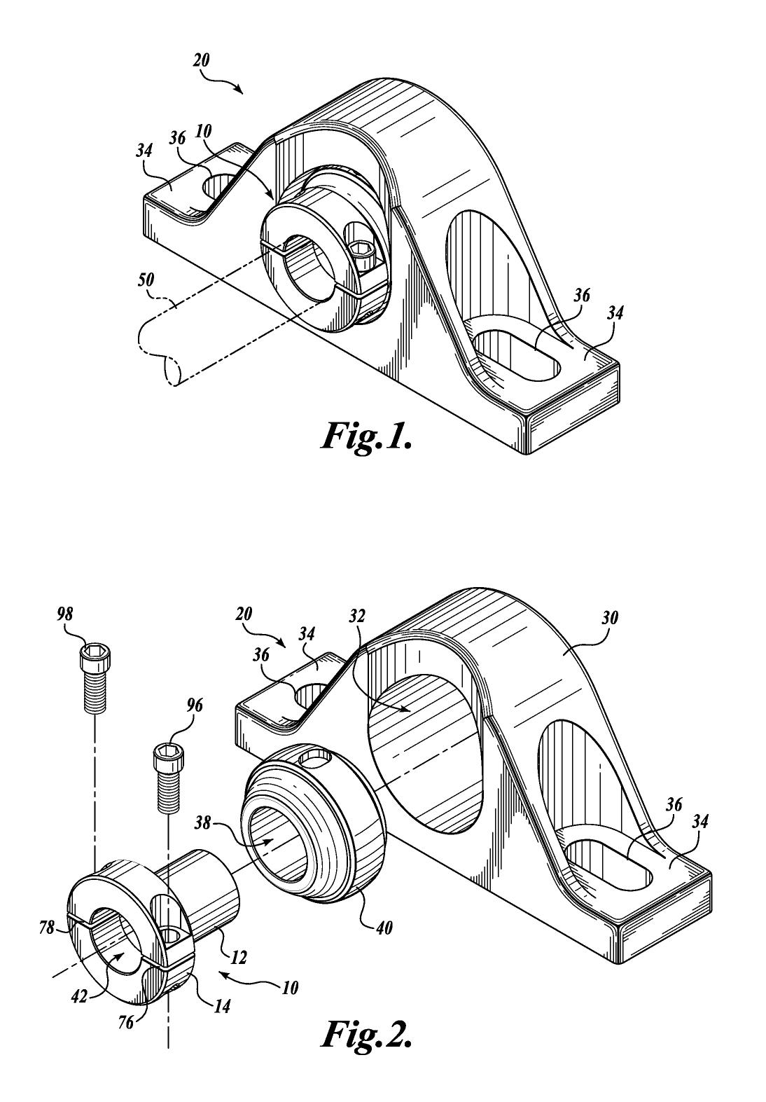

A split locking sleeve 10 formed in accordance with one embodiment of the disclosed technology is best seen by referring to FIGS. 1 and 2. The split locking sleeve 10 secures onto a shaft 50 (shown hidden) and acts as a journal inside a portion of a bearing assembly for the shaft. Although the split locking sleeve 10 may be used with any suitable bearing assembly, the split locking sleeve 10 will be hereinafter described with reference to a rotary plane bearing assembly 20 for ease of description. The illustrated rotary plane bearing assembly 20 includes a bearing insert 40 disposed within a housing 30. Any suitable bearing insert may be used, such as the Poly-Round® Bearing or the All-Round® Bearing made by EDT Corp., located in Vancouver, Wash. The bearing insert 40 includes a bore 38 sized and configured to rotatably receive a portion of the split locking sleeve 10 therein.

The housing 30 may be any suitable size and geometry that defines a bore 32 sized and configured to receive the bearing insert 40 in a manner well known in the art. At least one flange 34 or other suitable structure extends outwardly from the housing 30 for securing the housing 30 to a suitable mounting structure, such as a portion of a machine in which the bearing assembly 20 is being used. The flange 34 includes a through-hole 36 suitable for adjustably receiving a fastener and securing the housing 30 to the mounting structure. It should be appreciated that the rotary plane bearing assembly 20 may instead be constructed in any other suitable manner; and therefore, the foregoing description should not be seen as limiting the scope of the claimed subject matter.

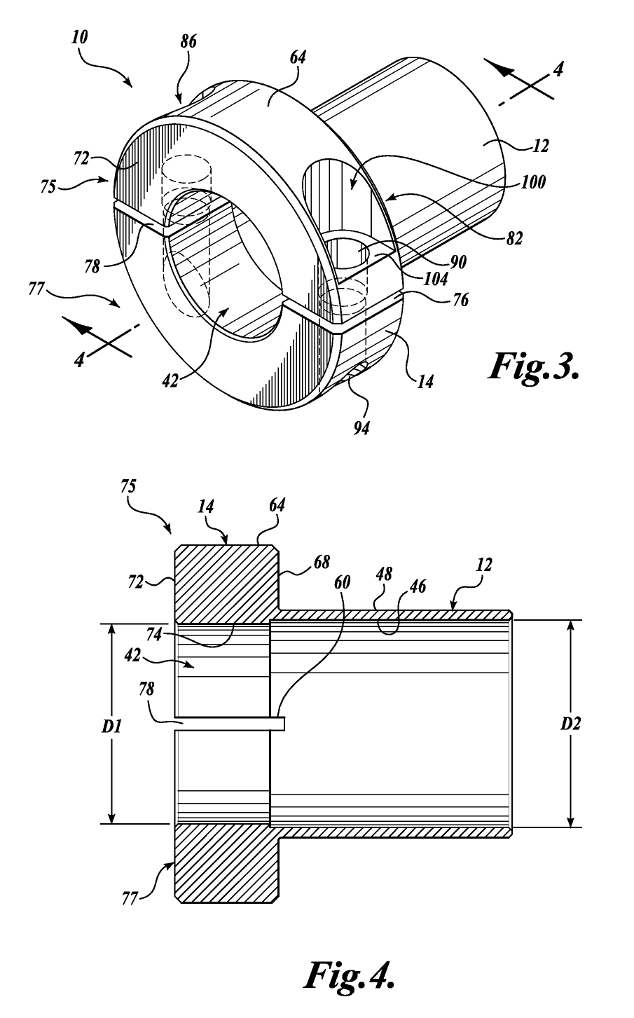

Referring to FIGS. 3 and 4, the split locking sleeve 10 suitable for acting as a journal for the shaft 50 inside a bearing assembly will now be described in detail. The split locking sleeve 10 includes a sleeve portion 12 integrally formed with a collar portion 14, wherein the sleeve portion 12 and collar portion 14 cooperatively define a split locking sleeve inner bore 42 configured to receive the shaft 50 therein. The split locking sleeve 10 may be made of any suitable material and may be made in any manner well know in the art. For instance, the split locking sleeve 10 may be constructed of a metal, such as stainless steel.

The sleeve portion 12 defines inner and outer cylindrical surfaces 46 and 48 having a contour that substantially match the outer curvature of the shaft 50. Moreover, the inner and outer cylindrical surfaces 46 and 48 are of a suitable axial length and define a suitable thickness therebetween such that the sleeve portion 12 may act as a journal inside the bearing insert 40 when received on the shaft 50. It should be appreciated that the shape, axial length, and thickness of the sleeve portion 12 may be changed to accommodate various shaft sizes and shapes and various bearing assembly configurations without departing from the scope of the present disclosure.

The collar portion 14 defines an enlarged outer diameter portion of the split locking sleeve 10 suitable for engaging the bearing insert 40 of the bearing assembly 20 to withstand thrust loads during operation. More specifically, the collar portion 14 includes first and second abutment surfaces 68 and 72 extending radially outwardly from the center axis of the split locking sleeve 10 and a collar outer surface 64 extending between the first and second abutment surfaces 68 and 72. The first and second abutment surfaces 68 and 72 and the collar outer surface 74 cooperatively define an annular collar portion 14 that is preferably substantially square or rectangular in cross-section, as shown in FIG. 4. The first abutment surface 68 extends between the collar outer surface 64 and the outer surface 48 of the sleeve portion 12 to define a shoulder between the sleeve portion 12 and the collar portion 14. As such, the shoulder may abut against the bearing insert 40 when the split locking sleeve 10 is received within the bearing assembly 20.

As stated above, the sleeve portion 12 and collar portion 14 cooperatively define a split locking sleeve inner bore 42 for receiving the shaft 50 therein. The split locking sleeve inner bore 42 includes a reduced diameter bore portion 74 having a predetermined diameter D1. The reduced diameter bore portion 74 extends from the outer edge of the collar portion 14 toward the sleeve portion 12 and preferably terminates prior to the intersection of the collar portion 14 and the sleeve portion 12. The split locking sleeve inner bore 42 further includes an increased diameter bore portion 46 having a predetermined diameter D2. The increased diameter bore portion 46 extends from the reduced diameter bore portion 74 toward the outer edge of the sleeve portion 12. Preferably, the diameters D1 and D2 are suitable to allow the split locking sleeve 10 to be tightly received on the shaft 50. However, the split locking sleeve 10 is not so tightly received on the shaft 50 such that the split locking sleeve 10 may not slide axially on the shaft 50 upon application of a predetermined force. In this manner, the axial location of the split locking sleeve 10 on the shaft 50 may be adjusted as needed to position the sleeve portion 12 within the bearing insert 40.

Referring to FIGS. 1-4, the split locking sleeve 10 includes an attachment assembly suitable to clamp the collar portion 14 onto the shaft 50 to withstand thrust loads imparted onto the collar portion during operation and to maintain the axial position of the split locking sleeve 10 on the shaft 50. Referring first to FIGS. 3 and 4, the attachment assembly is defined by first and second axial slots 76 and 78 formed substantially opposite one another on the collar portion 14. The first and second axial slots 76 and 78 extend radially from the split locking sleeve inner bore 42 and intersect from the collar outer surface 64. Moreover, the first and second axial slots 76 and 78 extend axially along the collar portion 14 from the second abutment surface 72 toward the sleeve portion 12. Preferably, the axial slots 76 and 78 extend slightly past the intersection of the increased and decreased diameter bore portions 46 and 74 and/or slightly past the intersection of the collar portion 14 and the sleeve portion 12. In this manner, the axial slots 76 and 78 cooperatively define first and second collar portions 75 and 77 that may be drawn together to clamp onto the shaft 50.

Referring to FIGS. 1-3, the attachment assembly further includes first and second pairs of openings 82 and 86 (the second pair 86 shown hidden in FIG. 3) extending tangentially across the collar portion 14 and through each axial slot 76 and 78, respectively. Each pair of openings 82 and 86 includes aligned non-threaded and threaded openings 90 and 94 adapted to receive first and second fasteners 96 and 98. Any suitable fasteners may be used, such as bolts having a threaded end and a head with a hexagonal socket. The threaded end of the fasteners 96 and 98 are passed through the non-threaded openings 90 and thereafter threaded into the threaded openings 94. It should be appreciated that both openings 90 and 94 may instead be non-threaded. In this manner, a bolt may be passed through the openings 90 and 94, and a nut may be thereafter received on the end of the bolt.

A partial tangential cavity 100 may be formed within the collar portion 14 that surrounds each non-threaded opening 90 (only one tangential cavity 100 shown for clarity). The cavities 100 define a bottom surface 104 that is substantially transverse to the axis of the non-threaded and threaded openings 90 and 94. As such, the bottom surface 104 defines a shoulder that is engageable by the head of the fastener such that the fastener may draw the upper and lower collar portions 75 and 77 together when the fastener is threaded into the openings 90 and 94. The tangential cavities 100 are also sized and shaped to receive the heads of each fastener 96 and 98 such that the heads do not protrude from the arcuate plane defined by the collar outer surface 64. In this manner, the fasteners 96 and 98 will not interfere with the machine or other assembly in which the split locking sleeve 10 is being used. If openings 94 are non-threaded for receiving a bolt and nut assembly as described above, a tangential cavity may also be formed within the collar portion 14 around each opening 94 to receive the nut and to define a surface against which the nut may abut to draw the collar portions together.

To clamp the collar portion 14 down onto the shaft 50, the threaded end of the fasteners 96 and 98 are passed through the non-threaded openings 90 and are thereafter threaded into the threaded openings 94 in any suitable manner, such as with the use of an allen key. Torque is applied to the fasteners such that the head of each fastener engages the surface 104 to draw the upper and lower collar portions 75 and 77 together and to decrease the gap defined by the axial slots 76 and 78. A predetermined amount of torque is applied to each of the fasteners 96 and 98 until the collar portion 14 is suitably clamped down onto the shaft 50 to withstand thrust loads during operation.

It should be appreciated that any other suitable attachment assembly may instead be used. As a non-limiting example, the collar portion 14 may instead include only one axial slot with one fastener extending across the slot to tighten the collar portion onto the shaft. As yet another non-limiting example, the axial slot(s) may extend onto the sleeve portion 12 or may instead extend along the entire axial length of the split locking sleeve 10. Moreover, it should be appreciated that any other suitable fastener or clamping mechanism may instead be used to secure the collar portion 14 onto the shaft 50. However, it is preferred that an adjustable attachment assembly be used such that the split locking sleeve 10 is suitable for use with shafts 50 of slightly varying diameter. For instance, the above-described attachment assembly is adjustable in that a desired amount of torque may be applied to the fasteners 96 and 98 to decrease the gap defined by the axial slots as needed to clamp onto the shaft 50.

Referring to FIGS. 1-4, the manner in which the split locking sleeve 10 is used will now be described. After mounting the bearing assembly housing 30 to a mounting structure as described above, the split locking sleeve 10 is slid onto a shaft 50 until the split locking sleeve 10 is positioned in a desired axial position. The collar portion 14 is then clamped onto the shaft 50 by threading the first and second fasteners 96 and 98 through openings 90 and 94 to draw the upper and lower collar portions 75 and 77 together.

The reduced diameter bore portion 74 of the split locking sleeve 10 allows the collar portion 14 to securely clamp onto the shaft without causing the split locking sleeve 10 to deform, crack, etc., at the areas of concentrated stress and strain in the split locking sleeve. As described above, the areas of concentrated stress and strain exist at the intersection of the collar portion 14 and the sleeve portion 12 and at the inner end of each axial slot 76 and 78. Defining a reduced diameter bore portion 74 within the collar portion 14 reduces the bending distance of the first and second collar portions 75 and 77 as they are drawn together and clamped onto the shaft 50. As such, the crinkling, cracking, warping, etc., that normally occurs at the areas of concentrated stress and strain in minimized or eliminated. Moreover, with the collar portion 14 having a reduced inner bore diameter D1 as compared to the inner bore diameter D2 of the sleeve portion 12, the sleeve portion 12 does not interfere with or otherwise prevent the collar portion 14 from tightly clamping onto the shaft 50. Thus, the split locking sleeve 10 incorporates the strong lateral holding power of a split collar without compromising the structural integrity, durability, and functionality of the design.

Once the split locking sleeve 10 is securely received on the shaft 50, the sleeve portion 12 of the split locking sleeve 10 may be slidably received within the bore 38 of the plane bearing 40, as shown in FIG. 1. The sleeve portion 12 protects the shaft 50 from the abrasion and normal wear caused by plane bearings. Moreover, the collar portion 14 securely clamps onto the shaft 50 to withstand thrust loads imparted onto the split locking sleeve 10 as a result of lateral shaft movement, vibrations, temperature cycling, etc.

While illustrative embodiments have been illustrated and described, it will be appreciated that various changes can be made therein without departing from the spirit and scope of the present disclosure.

The embodiments of the present disclosure in which an exclusive property or privilege is claimed are defined as follows:

1. A split locking sleeve for use with a shaft receivable within a portion of a bearing assembly, the split locking sleeve comprising:
(a) a sleeve portion having a first inner bore diameter sized and configured to receive a shaft therein;
(b) a collar portion integrally formed with the sleeve portion, the collar portion having a second inner bore diameter that is smaller than the first inner bore diameter; and
(c) an attachment assembly comprising:
(i) at least one axial slot extending along the collar portion to define first and second collar portions; and
(ii) at least one fastener receivable within the collar portion and configured to draw the first and second collar portions together.

2. The split locking sleeve of claim 1, wherein the axial slot further extends partially along the length of the sleeve portion.

3. The split locking sleeve of claim 1, wherein the axial slot extends along the length of the split locking sleeve.

4. The split locking sleeve of claim 1, wherein the collar portion includes first and second axial slots that extend along the collar portion.

5. The split locking sleeve of claim 4, further comprising first and second fasteners receivable within the collar portion and configured to draw the first and second collar portions together.

6. The split locking sleeve of claim 1, wherein the fastener extends across the axial slot.

7. The split locking sleeve of claim 1, wherein the fastener is threadably receivable within the collar portion to adjustably draw the first and second collar portions together.

8. The split locking sleeve of claim 1, wherein the fastener is passed through first and second openings in the collar portion, the first and second openings intersecting the axial slot.

9. The split locking sleeve of claim 8, wherein a nut is received on an end of the fastener after it is passed through the first and second openings.

10. The split locking sleeve of claim 1, wherein the collar portion includes a tangential cavity for receiving a portion of the fastener such that the fastener does not protrude from the arcuate outer surface defined by the collar portion.

11. A bearing assembly, comprising:
(a) a bearing insert received within a housing;
(b) a shaft;
(c) a split locking sleeve slidably receivable on the shaft and rotatably receivable within the bearing insert, the split locking sleeve comprising:
(i) a sleeve portion having a first inner bore diameter;
(ii) a collar portion integrally formed with the sleeve portion, the collar portion having a second inner bore diameter that is smaller than the first inner bore diameter; and
(iii) an attachment assembly comprising at least one axial slot extending along the collar portion to define first and second collar portions, and at least one fastener receivable within the collar portion and configured to draw the first and second collar portions together.

12. The bearing assembly of claim 11, wherein the axial slot further extends partially along the length of the sleeve portion.

13. The bearing assembly of claim 11, wherein the axial slot extends along the length of the split locking sleeve.

14. The bearing assembly of claim 11, wherein the collar portion includes first and second axial slots that extend along the collar portion.

15. The bearing assembly of claim 14, further comprising first and second fasteners receivable within the collar portion and configured to draw the first and second collar portions together.

16. The bearing assembly of claim 11, wherein the fastener is threadably receivable within the collar portion to adjustably draw the first and second collar portions together.

17. The bearing assembly of claim 11, wherein the fastener is passed through first and second openings in the collar portion, the first and second openings intersecting the axial slot.

18. The split locking sleeve of claim 17, wherein a nut is received on an end of the fastener after it is passed through the first and second openings.

19. The bearing assembly of claim 11, wherein the collar portion includes a tangential cavity for receiving a portion of the fastener such that the fastener does not protrude from the arcuate outer surface defined by the collar portion.

20. The bearing assembly of claim 11, wherein the fastener extends across the axial slot.
